(19) United States
(12) Patent Application Publication
(10) Pub. No.: US 2026/0129535 A1
(43) Pub. Date: May 7, 2026

(54) CO-LOCATED, CO-CHANNEL BASIC SERVICE SET IDENTIFIER (BSSID) SIGNALING AND BEHAVIOR

(71) Applicant: Cisco Technology, Inc., San Jose, CA (US)

(72) Inventors: Brian D. HART, Sunnyvale, CA (US); Malcolm M. SMITH, Richardson, TX (US); Binita GUPTA, San Diego, CA (US)

(21) Appl. No.: 19/281,645

(22) Filed: Jul. 26, 2025

Related U.S. Application Data
(60) Provisional application No. 63/717,765, filed on Nov. 7, 2024.
(60) Provisional application No. 63/744,042, filed on Jan. 10, 2025.
(60) Provisional application No. 63/775,857, filed on Mar. 21, 2025.

(51) Int. Cl. H04W 36/00

(52) U.S. Cl. CPC H04W 36/13; H04W 36/0061

(57) ABSTRACT

Combining MBSSID sets, co-hosted BSSID sets, and standalone VAPs into a co-located, co-channel BSSID set to allow for more efficient communication between different members of the co-located, co-channel BSSID set. By combining the members into the co-located, co-channel BSSID set, when a TXOP holder provides transmission time to a co-located, co-channel BSSID set, each of the VAPs in the co-located, co-channel BSSID set receives access to exchange data for a duration of time. When the co-located, co-channel BSSID set indicates to the TXOP holder that the VAPs finished exchanging data, each of the VAPs in the co-located, co-channel BSSID set loses access to send data.

### CROSS-REFERENCE TO RELATED APPLICATIONS

This application claims the benefit of co-pending U.S. provisional patent applications Ser. No. 63/717,765 filed Nov. 7, 2024, Ser. No. 63/744,042 filed Jan. 10, 2025, and Ser. No. 63/775,857 filed Mar. 21, 2025. The aforementioned related patent applications are herein incorporated by reference in their entirety.

### TECHNICAL FIELD

Embodiments presented in this disclosure generally relate to connecting virtual access points (VAPs). More specifically, embodiments disclosed herein associate multiple BSSIDs sets of VAPs together into a co-located, co-channel BSSID set.

### BACKGROUND

Stations (STAs) may associate with and/or setup links different Service Set Identifiers (SSIDs) on a physical access point (AP) device with one or more physical AP radios, where each AP radio implements multiple virtual APs (VAPs) that may be part of virtual Basic Service Sets (BSSs). Each of the BSSs may be either a Multiple BSSID (MBSSID) set or a co-hosted BSSID set, each including at least one VAP. A BSS might also be a standalone BSS. Because the STAs use different SSIDs, when exchanging data with different STAs on the physical AP radio through the VAPs, the physical AP radio would make or receive separate transmissions, or portions of transmissions, for each STA associated with the physical AP radio. The VAPs may send separate requests to a transmit opportunity (TXOP) holder for transmission time for the VAPs to exchange data with an associated STA. It may be inefficient, however, for the VAPs to send separate requests to the TXOP holder for transmission time to exchange data with each of the STAs, which reduces network performance.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts a diagram of a first VAP from one BSSID set communicating with a second VAP in a different BSSID set, according to one embodiment.

FIG. 2 depicts a diagram of messages between a VAP from one BSSID set with two VAPs in a different BSSID set, according to one embodiment.

FIG. 3 depicts a flowchart of a VAP from one BSSID set communicating with a second VAP in a different BSSID set, according to one embodiment.

FIG. 4 depicts a diagram of different co-located, co-channel BSSID setups, according to one embodiment.

FIG. 5 depicts an example network device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is an AP that includes one or more memories; and one or more processors communicatively coupled to the one or more memories, which are configured to, individually or collectively, perform operations. The operations include implementing a first VAP in a first BSSID set and a second VAP in a second BSSID set, with the first BSSID set being different from the second BSSID set. The operations further include receiving, one the first VAP, a request frame from the second VAP. The operations further include transmitting, from the first VAP, a response frame to the second VAP and receiving, on the first VAP, a handover frame from the second VAP indicating that the second VAP accepts the request frame, which indicates that the first VAP and a third VAP that is in the first BSSID set have access to exchange data. The embodiments may include a method and a non-transitory computer-readable medium.

### EXAMPLE EMBODIMENTS

The present disclosure describes improving efficiency of communications between STAs and VAPs using a co-located, co-channel BSSID set in addition to communications between VAPs located in different co-located, co-channel BSSID sets. When a STA (such as a phone, computer, etc.) connects to a network, the STA is associated with a physical AP radio (or multiple thereof in the case of Multi-Link Devices, MLDs) that is part of a network such that the STA may access the network. The physical AP radio may implement multiple VAPs that are located on the same physical AP radio (co-located, co-channel). Instead of the physical AP radio advertising one network, the VAPs allow for the physical AP to broadcast multiple networks (SSIDs). Each VAP may advertise a different BSSID when the STA is searching for a network to join.

The VAPs may be grouped into BSSID sets. For example, some VAPs may be grouped into a MBSSID set. For a MBSSID set, one of the VAPs may transmit a broadcast frame indicating that the VAP exists and include additional information about other “non-transmitted” VAPs in the MBSSID set. Similarly, one of the VAPs may transmit a response frame to a STA responding to a probe request frame from the STA with parameters of both transmitted and non-transmitted BSSs in the MBSSID set are reported. Alternatively, some VAPs may be grouped into a co-hosted BSSID set. Moreover, some VAPs are standalone VAPs that are not grouped with other VAPs. For standalone VAPs or co-hosted BSSID sets, each VAP may transmit a broadcast frame indicating that the VAP exists, and each VAP may transmit a response frame to a STA responding to a probe request frame from the STA. A probe request frame is a request sent from the STA to determine what networks are available for the STA to join.

The present disclosure describes a physical AP radio that further groups one or more MBSSID sets, co-hosted BSSID sets, or standalone VAPs into a co-located, co-channel BSSID set. The physical AP radio may then use the co-located, co-channel BSSID set to coordinate transmissions. For example, a TXOP holder is a VAP or BSSID set that is given transmission time to transmit multiple frames from the physical AP radio that implements the VAP or the BSSID set. The transmission time provides the VAP or BSSID set a duration to exchange data with an associated STA. For a first VAP in the same co-located, co-channel BSSID set as a TXOP holder, the first VAP may exchange frames with an associated STA without requesting transmission time from the TXOP holder. In one embodiment, a second VAP in the same co-located, co-channel BSSID set as the first VAP, may exchange frames with an associated STA in the same physical layer protocol data unit (PPDU) as the first VAP. For a second VAP in a different co-located, co-channel BSSID set than the TXOP holder, the second VAP may request transmission time from the TXOP holder, and the TXOP holder may provide time to the second VAP such that the second VAP may transmit frames. By giving time to the second VAP in the other co-located, co-channel BSSID set, each VAP in the other co-located, co-channel BSSID set also receives time to transmit frames in the same manner as the second VAP that was given time. For example, consider a first co-located, co-channel BSSID set includes a MBSSID set with three VAPs and a second co-located, co-channel BSSID set includes the TXOP holder. When one of the three VAPs in the MBSSID set requests transmission time from the TXOP holder, the second co-located, co-channel BSSID set provides the VAP in the MBSSID set time (wireless resources) to exchange frames and the other two VAPs in the MBSSID set would also be allowed to exchange frames. When the VAPs in the MBSSID set finish exchanging frames, one of the VAPs may indicate to the TXOP holder that VAPs are done exchanging frames. This communication between MBSSID, co-hosted, co-located, co-channel BSSID sets occurs by sharing information between each of the VAPs in the co-located, co-channel BSSID set along with setting a field in a frame from the VAP indicating that the VAP is part of a co-located, co-channel BSSID set. In one embodiment, sharing information between VAPs may be limited to an MBSSID, co-hosted, or co-located, co-channel BSSID set.

In some embodiments, the described system provides several technical advantages. For example, grouping a combination of MBSSID sets, co-hosted BSSID sets, and standalone VAPs into a co-located, co-channel BSSID set allows the VAPs in the co-located, co-channel BSSID set to exchange data through the TXOP with less control frames. Instead of authorizing each VAP to exchange data through the TXOP by sending control frames to the TXOP holder, the TXOP holder provides time for a co-located, co-channel BSSID set, which allows VAPs in the co-located, co-channel BSSID set to exchange data without individual authorization. Additionally, when a VAP or BSSID set in the co-located, co-channel BSSID set is the TXOP holder, each VAP in the co-located, co-channel BSSID set may exchange data without authorization from the TXOP holder. By decreasing the amount of control frames sent to exchange data from VAPs, the efficiency of data transmission increases. Similarly, by using one MBSSID set, one co-hosted BSSID set, or a subset of the one MBSSID set or the one co-hosted BSSID set, the efficiency of data transmission increases.

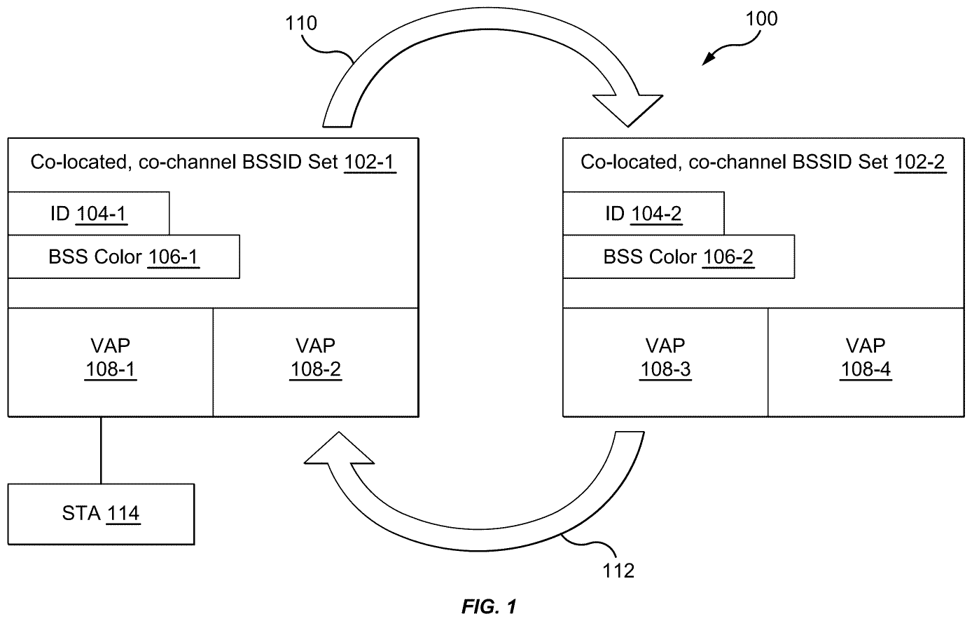

FIG. 1 depicts a diagram of a system 100 that includes a VAP 108-1 from a co-located, co-channel BSSID set 102-1 communicating with a VAP 108-3 in a co-located, co-channel BSSID set 102-2. The VAP 108-1 and VAP 108-2 are grouped into the co-located, co-channel BSSID set 102-1. The VAP 108-3 and VAP 108-4 are grouped into the co-located, co-channel BSSID set 102-2. In an exemplary embodiment, the VAPs 108-1 through 108-4 are implemented by the same physical AP radio. A STA may associate with one of the VAPs 108-1 through 108-4 to connect to join a network. In an exemplary embodiment, a STA 114 associates with the VAP 108-1. The co-located, co-channel BSSID sets 102-1 and 102-2 may include an identifier (ID) 104-1 or 104-2 and BSS color 106-1 or 106-2, respectively. The IDs 104-1 and 104-2 identify the co-located, co-channel BSSID sets 102-1 and 102-2, respectively. The IDs 104-1 and 104-2 may include multiple parameters. For example, a first parameter may be a 48-bit BSSID, a MAC address, or a portion of the BSSID or the MAC address. The first parameter may include bits that indicate letters, numbers, symbols, or some combination thereof. In an exemplary embodiment, the IDs 104-1 and 104-2 includes a first parameter that includes a BSSID portion, which includes numbers in a hexadecimal format. The IDs 104-1 and 104-2 may include a second parameter that is a number that indicates or is used to determine the amount of VAPs that are in the respective co-located, co-channel BSSID set 102-1 or 102-2. This number may be a number within the IDs 104-1 and 104-2. The number may be used in a formula to calculate the maximum amount of VAPs that may be in the respective co-located, co-channel BSSID set 102-1 or 102-2. For example, the first parameter in the ID 104-1 may be 0x0a1b2c3d4e52 and the second parameter (N) is 4. The maximum amount of VAPs that may be in the co-located, co-channel BSSID set 102-1 may be determined using the formula 2^{N} (in this example 2⁴=16). In one embodiment, the second parameter may be used in conjunction with the first parameter. For example, given the second parameter of the ID 104-1 equals 4, then 16 different BSSIDs may be covered, and then each of the bits except the 4 least significant bits (LSB) may be included in each BSSID of the VAPs in the set. The first parameter of the ID 104-1 may be represented as 0x0a1b2c3d4e50, 0x0a1b2c3d4e52, 0x0a1b2c3d4e5*, 0x0a1b2c3d4e5.The first parameter along with the second parameter may define a range of BSSIDs 0x0a1b2c3d4e50 through 0x0a1b2c3d4e5f (inclusive).

Each VAP that is in the co-located, co-channel BSSID set 102-1 or 102-2 may be assigned an address. In one embodiment, each address for each of the VAPs in the co-located, co-channel BSSID set 102-1 or 102-2 are assigned based on the IDs 104-1 or 104-2, respectively. Using the previous example, the VAP 108-1 may be assigned an address of 0x0a1b2c3d4e50 because it is a first VAP in the co-located, co-channel BSSID set 102-1. The VAP 108-2 may be assigned an address of 0a1b2c3d4e51 because it is a second VAP in the co-located, co-channel BSSID set 102-1. The addresses for the VAPs in the co-located, co-channel BSSID set 102-1 may range from 0x0a1b2c3d4e50 through 0x0a1b2c3d4e5f. When one of the VAPs 108-1 through 108-4 sends a message to a VAP in a different co-located, co-channel BSSID set, the message may include the respective address for the VAP.

In some embodiments, transmissions sent from the VAPs 108-1 through 108-4 include a subfield indicating that the VAPs 108-1 through 108-4 are part of a co-located, co-channel BSSID set. In one embodiment, when the subfield is set to one, the subfield indicates that the VAP is part of a co-located, co-channel BSSID set. When the subfield is set to zero, the subfield indicates that the VAP is not part of a co-located, co-channel set.

In some embodiments, the co-located, co-channel BSSID sets 102-1 and 102-2 include a combination of Multiple BSSID (MBSSID) sets, co-hosted BSSID sets, and standalone VAPs that are located on the same physical AP radio (co-located, co-channel). Each of the MBSSID sets and co-hosted BSSID sets may be a grouping of VAPs. When transmitting a beacon or transmitting a response to a probe, a MBSSID set may transmit a BSSID of one VAP in the MBSSID set. A co-hosted BSSID set may transmit a separate beacon and probe response for each VAP in the co-hosted BSSID set using a BSSID of the VAP. The VAPs in the MBSSID sets or co-hosted BSSID sets may function the same as the VAPs 108-1 through 108-4 described above.

When one of the STAs associated with one of the VAPs 108-1 through 108-4 wants to exchange data, such as with the STA 114, the VAPs may request transmission time from a TXOP holder to exchange the data. In an embodiment, the TXOP holder is one of the co-located, co-channel BSSID sets 102-1 or 102-2. In an embodiment, one of the VAPs 108-1 through 108-4 is the TXOP holder. The TXOP holder may grant transmission time to another co-located, co-channel BSSID set through coordinated time-division multiple access (Co-TDMA) or coordinated spatial reuse (Co-SR), which may allow VAPs in the co-located, co-channel BSSID set to exchange data for a duration of time. For example, the TXOP holder may be the co-located, co-channel BSSID set 102-1. A STA associated with the VAP 108-3 (or the VAP 108-4) in the co-located, co-channel BSSID set 102-2 may have data to exchange. In one embodiment, the co-located, co-channel BSSID set 102-1 determines that the VAP 108-3 wants transmission time to exchange data during communication between the co-located, co-channel BSSID set 102-1 and 102-2 (e.g., using control frames communicated between the co-located, co-channel BSSID sets 102-1 and 102-2). In one embodiment, the VAP 108-3 transmits a request for transmission time to the co-located, co-channel BSSID set 102-1. The co-located, co-channel BSSID set 102-1 may provide transmission time to the co-located, co-channel BSSID set 102-2 (e.g., indicated using signal 110). The transmission time granted by the TXOP holder may be used by STAs associated with the VAPs 108-3 and 108-4 to exchange data with the STAs. When the STAs and the VAPs 108-3 and 108-4 finish exchanging data, the co-located, co-channel BSSID set 102-2 may indicate to the co-located, co-channel BSSID set 102-1 that the STAs and the VAPs 108-3 and 108-4 finished exchanging data using signal 112, and the TXOP holder may remove access from the STAs and the VAPs 108-3 and 108-4 to send data. By having VAPs that are co-located, co-channel in one of the co-located, co-channel BSSID sets 102-1 or 102-2, sending messages between VAPs in the same co-located, co-channel BSSID set 102-1 or 102-2 may use no control frames. For example, when the VAP 108-1 is the TXOP holder, the VAP 108-1 may allow each VAP in the co-located, co-channel BSSID set 102-1 to send data during the TXOP. This allows the VAP 108-2 to exchange data with a STA or receive data from the STA without requesting transmission time from the VAP 108-1 through communicating control frames with the VAP 108-1.

The communications between the VAPs 108-1 through 108-4 may come from a STA associated with one of the VAPs 108-1 through 108-4 trying to communicate with another STA. When a STA associated with the VAPs 108-1 through 108-4 begins communication, the transmission may indicate a MAC address equal to the ID 104-1 or 104-2. While the transmission has the MAC address equal to the ID 104-1 or 104-2, the STA remains in an awake mode. After communication is completed, the STA may enter a power-saving mode.

VAPs that are part of a co-located, co-channel BSSID set may use the same BSS color or no color when transmitting messages or receiving messages. In an exemplary embodiment, the VAP 108-1 uses the BSS color 106-1 and the VAP 108-3 uses the BSS color 106-2 when communicating with each other.

Each of the VAPs 108-1 through 108-4 may receive a report indicating the VAPs and BSSID sets that are nearby. In one embodiment, the report is a reduced neighbor report (RNR). The VAPs 108-1 through 108-4 and BSSID sets 102-1 and 102-2 may be set based on a target beacon transmission time (TBTT) Information field using reserved bits in an existing subfield or by adding a new subfield to a frame sent during transmission. In one embodiment, a bit to signal a co-located, co-channel BSSID exists is set to 1 to indicate that one of the VAPs 108-1 through 108-4 in the RNR is part of the co-located, co-channel BSSID sets 102-1 or 102-2. Another bit may be set to 1 to indicate that the VAP in the RNR has a transmitted BSSID equal to the ID 104-1 or 104-2 of the co-located, co-channel BSSID set 102-1 or 102-2, respectively. This bit may be set to 0 to indicate that the VAP has a transmitted BSSID not equal to the ID 104-1 or 104-2 of the co-located, co-channel BSSID set 102-1 or 102-2, respectively.

In one embodiment, all STAs associated with one of the VAPs 108-1 and 108-2 in the co-located, co-channel BSSID Set 102-1 are assigned distinct association identifiers (AIDs). The AIDs of the STAs may be assigned based on certain conditions of the VAP (in the co-located, co-channel BSSID set) with which the STAs are associated, such as the VAPs 108-1 and 108-2 or the co-located, co-channel BSSID set 102-1. For example, three STAs associated with the VAP 108-1 may be assigned 18, 19, and 22 while three STAs associated with the VAP 108-2 may be assigned 20, 21, and 23. By having each STA assigned a different AID, each STA may participate in the same orthogonal frequency-division multiple access (OFDMA)PPDU, multi-user, multiple input, multiple output (MU-MIMO) PPDU, or OFDMA-of-MU-MIMO PPDU. The OFDMA PPDU allows simultaneous transmission to and from multiple STAs via different frequency resources. The MU-MIMO PPDU allows for exchanging data with multiple STAs at the same time through different spatial (or antenna) resources. OFDMA-of-MU-MIMO PPDU is a combination of the OFDMA process and MU-MIMO for efficient transmissions to and transmissions from STAs associated to one of the VAPs 108-1 through 108-4. In one embodiment, the traffic indication map (TIM) element of beacons transmitted from the VAPs 108-1 and 108-2 may be the same regardless of the VAP that sent the beacon. This may occur by pooling information from the co-located, co-channel BSSID set between the VAPs 108-1 and 108-2. In one embodiment, the TIM element of a beacon from the VAP 108-1 reflects buffered traffic for STAs associated with the VAP 108-1, while the TIM element of a beacon from the VAP 108-2 reflects buffered traffic for STAs associated with the VAP 108-2.

While each of the AIDs for STAs associated with VAPs in the co-located, co-channel BSSID set 102-1 may be different, the AIDs may be different from other STAs relative to the same VAP, but not to STAs associated with another VAP. In one embodiment, the AIDs for STAs associated with the VAP 108-1 are different IDs, but the AIDs may be equal to the AIDs for STAs associated with the VAP 108-2. Because each STA may not have the same AID, the STAs for each VAP would receive separate PPDUs instead of one PPDU for all the STAs for each of the VAPs in one of the co-located, co-channel BSSID sets 102-1 or 102-2. Each of the PPDUs may be sent in the same TXOP when the IDs 104-1 or 104-2 are used to identify the TXOP holder. Additionally, a TXOP may be used by both co-located, co-channel BSSID sets 102-1 and 102-2 using Co-TDMA or Co-SR to provide separate PPDUs to each STA associated with a VAP in the respective co-located, co-channel BSSID sets 102-1 or 102-2.

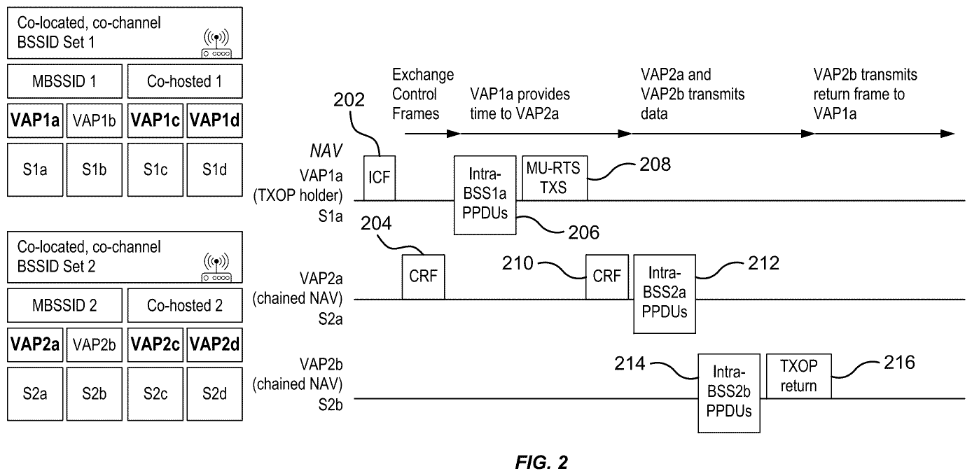

FIG. 2 depicts a diagram of messages between a VAP (such as the VAPs 108-1 and 108-2 in FIG. 1) from one co-located, co-channel BSSID set (such as the co-located, co-channel BSSID set 102-1 in FIG. 1) to VAPs (such as the VAPs 108-3 and 108-4 in FIG. 1) in a different co-located, co-channel BSSID set (such as the co-located, co-channel BSSID set 102-2). The example of FIG. 2 shows two co-located, co-channel BSSID sets, Co-located, co-channel BSSID Set 1 and Co-located, co-channel BSSID Set 2. Co-located, co-channel BSSID Set 1 includes an MBSSID set (MBSSID 1) and a co-hosted BSSID set (Cohosted 1). Co-located, co-channel BSSID Set 2 includes an MBSSID set (MBSSID 2) and a co-hosted BSSID set (Cohosted 2). MBSSID 1 includes two VAPs (VAP1a and VAP1b). Cohosted 1 includes two VAPs (VAP1c and VAP1d). MBSSID 2 includes two VAPs (VAP2a and VAP2b). Cohosted 2 includes two VAPs (VAP2c and VAP2d). STA S1a is associated with VAP1a. STA S1b is associated with VAP1b. STA S1c is associated with VAP1c. S1d is associated with VAP1d. STA S2a is associated with VAP2a. STA S2b is associated with VAP2b. STA S2c is associated with VAP2c. STA S2d is associated with VAP2d.

Each MBSSID set may have a BSSID value set equal to a BSSID value of a VAP in the MBSSID set. For example, MBSSID 1 may have a BSSID value equal to the BSSID of VAP1a, and MBSSID 2 may have a BSSID value equal to the BSSID of VAP2a. These values may be used for transmitting beacon or probe responses from the MBSSID set for each VAP in the MBSSID set. VAPs in a co-hosted BSSID set send the respective BSSID of the VAP for each beacon or probe response. For example, VAP1c may send the BSSID value of VAP1c in beacons or probe responses, and VAP1d may send the BSSID value of VAP1d in beacons or probe responses. VAP2c and VAP2d may similarly send the BSSID value of the respective VAP. Each value that is transmitted for beacons or probe responses is indicated in bold in FIG. 2.

In the example of FIG. 2, VAP1a in Co-located, co-channel BSSID Set 1 is a TXOP holder. A network allocation vector (NAV) is used alongside the TXOP holder to track traffic through the VAPs. VAP1a may provide transmission time for another VAP in a different co-located, co-channel BSSID set to transfer data for a duration of time. For example, VAP1a transmits an initial control frame (ICF) 202 to VAP2a that is in Co-located, co-channel BSSID Set 2. The ICF 202 may include a field asking if VAP2a has data to exchange. VAP2a may respond to the ICF 202 with a control frame response (CRF) 204 to acknowledge receipt of the ICF 202. The CRF 204 may include a field indicating that VAP2a has data to exchange. For example, the STA S2a may have data to exchange. The CRF 204 may include a field indicating that VAP2a is in Co-located, co-channel BSSID Set 2. The CRF 204 may include an acknowledgment from each other VAP in Co-located, co-channel BSSID Set 2. VAP1a may then exchange data using Intra-BSS1a PPDUs 206. Then, VAP1a provides transmission time to VAP2a by transmitting a multi-user request-to-send TXOP Sharing (MU-RTS TXS) 208. A MU-RTS TXS 208 provides a portion of the TXOP to use for exchanging data for a configurable amount of time. The MU-RTS TXS 208 may include a field indicating an ID for Co-located, co-channel BSSID Set 2.

When VAP2a receives the MU-RTS TXS 208, each other VAP in Co-located, co-channel BSSID Set 2 receives transmission time to exchange data on the TXOP for the configurable amount of time. VAP2a may transmit another CRF 210 to VAP1a acknowledging that VAP2a received the MU-RTS TXS 208. VAP2a may use the TXOP and Intra-BSS2a PPDUs 212 to exchange data with the STA S2a, or the STA S2a may be triggered to use the TXOP and the Intra-BSS2a PPDUs 212 to exchange data. VAP2b may also use the TXOP to exchange data with Intra-BSS2b PPDUs 214. Similarly, VAPs (e.g., the VAPs 1c, 1d, 2c, and 2d) in a co-hosted BSSID set (e.g., the cohosted 1 and 2) and STAs (e.g., the STA S1c, S1d, S2c, and S2d) associated with the VAPs may function the same as described between VAP1a and VAP2a. In one embodiment, VAP2c and VAP2d also exchange data during the TXOP. When the VAPs in Co-located, co-channel BSSID Set 2 finish transferring data, or when the configured amount of time expires, one of the VAPs in Co-located, co-channel BSSID Set 2 transmits a TXOP return frame 216 to the TXOP holder. In an exemplary embodiment, VAP2b transmits the TXOP return frame 216 to VAP1a. When VAP1a receives the TXOP return frame 216, VAP1a or any other VAP in Co-located, co-channel BSSID Set 1 (e.g., VAP1b, VAP1c, or VAP1d) may exchange data during the TXOP.

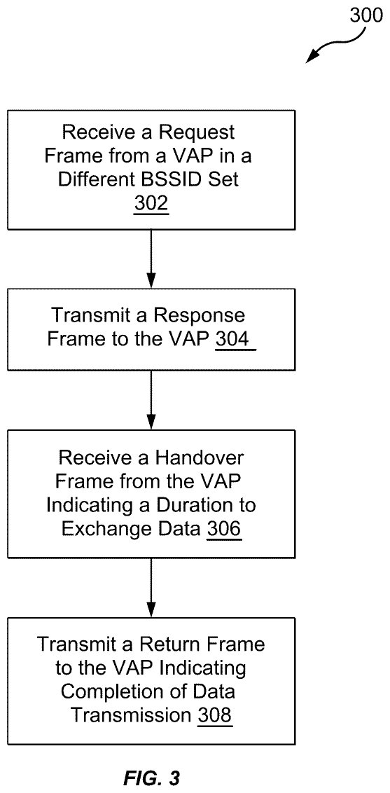

FIG. 3 depicts a flowchart of a method 300 for a first VAP (such as the VAPs 108-1 through 108-4 in FIG. 1) in a first BSSID set (such as the co-located, co-channel BSSID set 102-1 in FIG. 1) communicating with a second VAP in a second BSSID set (such as the co-located, co-channel BSSID set 102-2 in FIG. 1). At block 302, the first VAP receives a request frame from the second VAP. The second VAP may be TXOP holder, which may provide the first VAP with a duration to exchange frames. The second VAP may transmit a request to other STAs to determine if the STAs need time to exchange frames with an associated STA. At block 304, the first VAP transmits a response frame to the second VAP. The response frame may indicate that the first VAP has data exchange with an associated STA.

Based on the indication that the first VAP has data to exchange, at block 306, the first VAP receives a handover frame from the second VAP indicating that the first VAP has been provided with a duration of time to exchange data. The second VAP may provide resources to the first VAP for the first VAP to exchange data. When the first VAP is given a duration to exchange data from the TXOP holder, each other VAP in the first BSSID set may also have access to exchange data for the given time. In one embodiment, the handover frame has a field indicating that the first VAP has the duration of time to exchange data.

At block 308, the first VAP transmits a return frame to the second VAP indicating that the first VAP finished exchanging data. When the first VAP along with the other VAPs in the first BSSID set finish exchanging data, the first VAP may indicate to the TXOP holder (the second VAP) that the VAPs in the first BSSID set have finished exchanging data, which may lead to the VAPs in the first BSSID set losing access to exchange data.

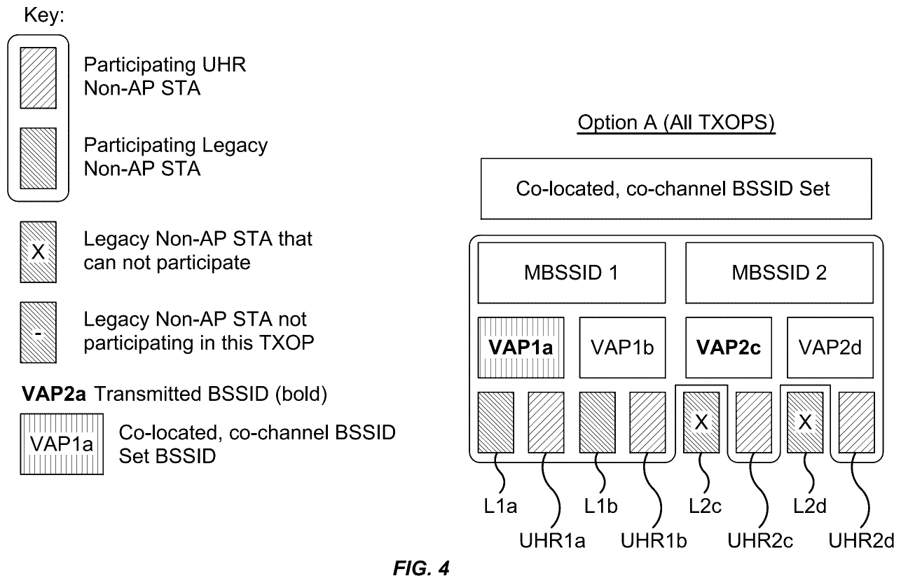

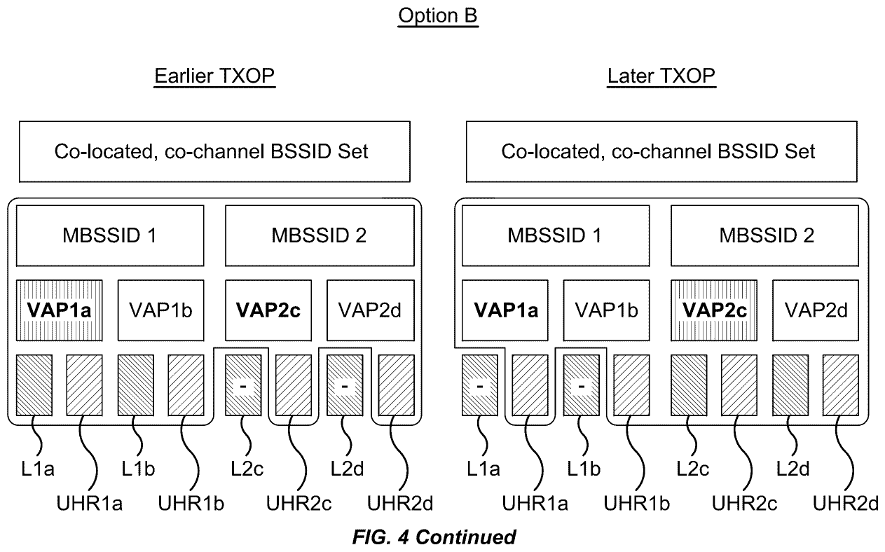

FIG. 4 depicts a diagram of different options (Option A and Option B) for setups for co-located, co-channel BSSID sets. The example in FIG. 4 shows a co-located, co-channel BSSID set including two MBSSID sets, MBSSID 1 and MBSSID 2. MBSSID 1 includes two VAPs (VAP1a and VAP1b). MBSSID 2 includes two VAPs (VAP2c and VAP2d). Two STAs (L1a and UHR1a) are associated with VAP1a. Two STAs (L1b and UHR1b) are associated with VAP1b. Two STAs (L2c and UHR2c) are associated with VAP2c. Two STAs (L2d and UHR2d) are associated with VAP2d. Each co-located, co-channel BSSID set may include a BSSID that is transmitted with messages from the co-located, co-channel BSSID set. For example, the co-located, co-channel BSSID set in FIG. 4 may use the BSSID of VAP1a when transmitting messages (as indicated by the vertical lines behind VAP1a). Depending on the type of STA that is associated with VAPs in the co-located, co-channel BSSID set, the STA may not recognize the BSSID of the co-located, co-channel BSSID set. A STA may be able to recognize a co-located, co-channel BSSID, an MBSSID, and a BSSID of an associated VAP in a frame. In one embodiment, if a co-located, co-channel BSSID set is signaled in a frame, the STA may track the BSSID of the associated VAP and the co-located, co-channel BSSID, but not the MBSSID. An ultra high reliability (UHR) STA may recognize a BSSID of a co-located, co-channel BSSID set is equal to an address of a MBSSID (e.g., MBSSID 1 or 2 in FIG. 4) or an address of a VAP (e.g., VAP1a, VAP1b, VAP2c, or VAP2d in FIG. 4) in the co-located, co-channel BSSID set. A legacy STA may recognize an address of an MBSSID or a VAP that the STA is associated with and may compare the address in a received frame to the address of the MBSSID or the VAP that the STA is associated with. In one embodiment, the legacy STA may not recognize the address of the MBSSID. For example, the legacy STA L1a may recognize an address of MBSSID 1 and may recognize an address of VAP1a. The legacy STA compares these to an address in frames of the co-located, co-channel BSSID set to determine if the address matches. If the address matches, then the legacy STA may participate in the TXOPs. Otherwise, the legacy STA may determine that the frames from a co-located, co-channel BSSID set is a different VAP or MBSSID and may not participate in the TXOP. In an exemplary embodiment, L1a may compare the address in received frames to the BSSID of VAP1a since the BSSID VAP1a is the BSSID used as the co-located, co-channel BSSID set BSSID (as indicated in bold) and determine that the BSSIDs are equal. In an exemplary embodiment, the legacy STA L1b may compare the address of a frame to the address of VAP1a (as the transmitted BSSID of MBSSID 1) and to the address of VAP1b (as its associated VAP). In an embodiment, VAP1a and VAP1b are part of a co-hosted BSSID set in the co-located, co-channel BSSID set. In this embodiment, the VAP1a and VAP1b each transmit separate beacon and probe response frames, so a legacy STA associated with the VAP1a would compare the address of a frame to the address of VAP1a to the address of the co-located, co-channel BSSID set. A legacy STA associated with VAP1b would compare the address of VAP1b to the address of the co-located, co-channel BSSID set.

Option A depicts a co-located, co-channel BSSID set with a BSSID that does not change between TXOPs. In Option A, the co-located, co-channel BSSID set has a BSSID equal to the address of VAP1a in MBSSID 1 (as indicated by the vertical stripes for VAP1a in FIG. 4). Each STA associated with VAP1a (L1a and UHR1a) and VAP1b (eL1b and UHR1b) may participate in a TXOP for the co-located, co-channel BSSID set because the UHR STAs (UHR1a and UHR1b) recognize the VAP1a is part of the co-located, co-channel BSSID set and the legacy STAs (L1a and L1b) recognize the address of the VAP1a. Similarly, the UHR STAs associated with VAP2c (UHR2c) and VAP2d (UHR2d) may recognize the BSSID of the co-located, co-channel BSSID set and accept frames with that address. However, the STAs marked with an “X” indicates legacy STAs (L2c and L2d) do not recognize the co-located, co-channel BSSID since that address does not match the address of the VAP2c (the associated AP) or the address of MBSSID 2. The legacy STAs may use the address of the VAP2c because the transmitted BSSID (indicated in bold) for beacons for the MBSSID 2 is the address of VAP2c. These legacy STAs may be unable to participate in the TXOP. This may result in the legacy STAs with an “X” going into a sleep or power-saving mode. Each of the STAs that may participate in the TXOP are indicated by a box around the STAs, VAPs, and MBSSIDs, while the legacy STAs that may not be able to participate in the TXOP are left out of the box.

Option B depicts a co-located, co-channel BSSID set that rotates between using the addresses of VAPs in two MBSSIDs as the BSSID for the co-located, co-channel BSSID set. The co-located, co-channel BSSID set may rotate between the addresses during different TXOPs. In Option B, during an earlier TXOP, the co-located, co-channel BSSID set has a BSSID equal to the address of VAP1a (as indicated by the vertical stripes for VAP1a in FIG. 4) in MBSSID 1. Similar to Option A, each STA associated with VAP1a (L1a and UHR1a) and VAP1b (L1b and UHR1b) may participate in a TXOP because the UHR STAs (UHR1a and UHR1b) recognizes the VAP1a is part of the co-located, co-channel BSSID set and the legacy STAs (L1a and L1b) recognize the address of the VAP1a. Similarly, the UHR STAs associated with VAP2c (UHR2c) and VAP2d (UHR2d) recognize the BSSID of the co-located, co-channel BSSID set and accept frames with that address. However, the STAs marked with a “-” indicates legacy STAs (L2c and L2d) do not recognize the co-located, co-channel BSSID since that address does not match the address of the VAP2c (the associated AP) or the address of MBSSID 2. This may result in the legacy STAs with a “-” going into a sleep or power-saving mode. Each of the STAs that may be able to participate in the TXOP are indicated by a box around the STAs, VAPs, and MBSSIDs, while the legacy STAs that are unable to participate in the TXOP are left out of the box.

In Option B, during a later TXOP, the BSSID of co-located, co-channel BSSID set is set to the address of the VAP2c (as indicated by the vertical stripes behind VAP2c in FIG. 4) in MBSSID 2. Each of the STAs associated with the VAP2c (L2c and UHR2c) and the VAP2d (L2d and UHR2d) may participate in the earlier TXOP because the UHR STAs (UHR2c and UHR2d) recognize the VAP2c is part of the co-located, co-channel BSSID set and the legacy STAs (L2c and L2d) recognize the address of the VAP2c. Similarly, the UHR STAs associated with VAP1a (UHR1a) and VAP1b (UHR1b) recognize the BSSID of the co-located, co-channel BSSID set and accept frames with that address. However, the STAs marked with a “-” indicates legacy STAs (L1a and L1b) do not recognize the co-located, co-channel BSSID since that address does not match the address of the VAP1a (the associated AP of L1a) or the VAP1b (the associated AP of L1b) or the address of MBSSID 1. This may result in the legacy STAs with a “-” going into a sleep or power-saving mode. Each of the STAs that may be able to participate in the TXOP are indicated by a box around the STAs, VAPs, and MBSSIDs, while the legacy STAs that may not be able to participate in the TXOP are left out of the box.

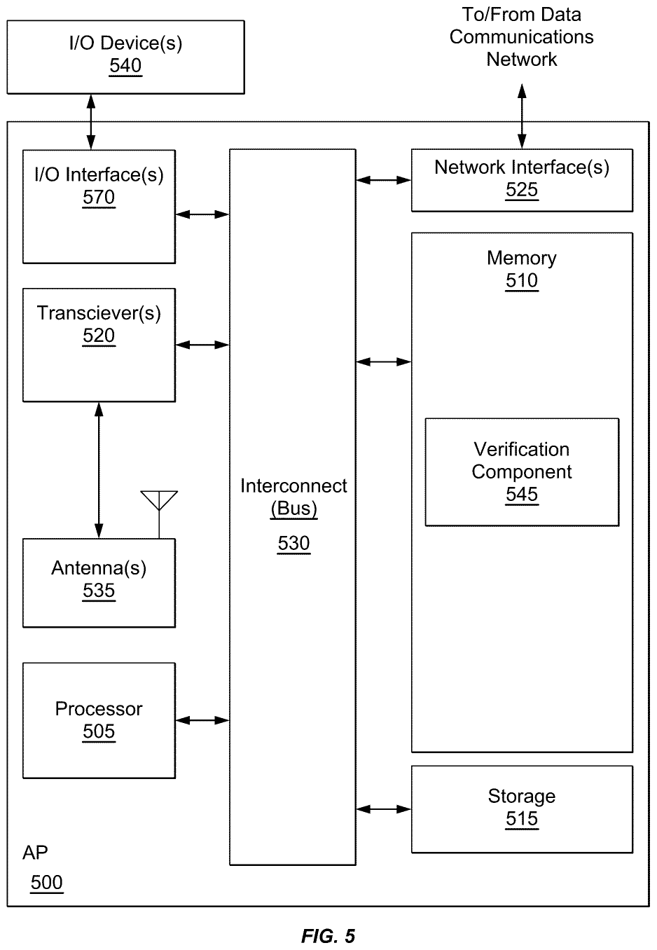

FIG. 5 depicts an example network device 500 configured to perform various aspects of the present disclosure, according to some aspects of the present disclosure. The network device 500 may be an AP, which corresponds to the physical AP radio that implements the VAPs 108-1 through 108-4 as depicted in FIG. 1.

As illustrated, the example network device 500 includes a processor 505, memory 510, storage 515, one or more transceivers 520, one or more I/O interfaces 580, and one or more network interfaces 525. In some embodiments, I/O devices 540 are connected via the I/O interface(s) 580. Further, via the network interface 525, the network device 500 can be communicatively coupled with one or more other devices and components (e.g., via a network, which may include the Internet, local network(s), and the like). Each of the components is communicatively coupled by one or more buses 530. In some embodiments, one or more antennas 535 may be coupled to the transceivers 520 for transmitting and receiving wireless signals.

The processor 505 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 505 processes information received through the transceiver 520, I/O interfaces 580, and the network interfaces 525. The processor 505 retrieves and executes programming instructions stored in memory 510, as well as stores and retrieves application data residing in storage 515.

The storage 515 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 515 may store a variety of data for the efficient functioning of the system.

The memory 510 may include random access memory (RAM) and read-only memory (ROM). The memory 510 may store processor-executable software code containing instructions that, when executed by the processor 505, enable the network device 500 to perform various functions described herein for wireless communication. In the illustrated example, the memory 510 includes a software component: verification component 545.

In one embodiment, the verification component 545 is configured to verify other devices and be verified by other devices. More specifically, the verification component 550 may be used for another physical AP radio to determine if a VAP (e.g., the VAPs 108-1 through 108-4) in a co-located, co-channel BSSID set on the network device 500 has data to exchange and if the co-located, co-channel BSSID set is a TXOP holder.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system. ” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point (AP) comprising:
one or more memories; and
one or more processors communicatively coupled to the one or more memories, wherein the one or more processors are configured to, individually or collectively, perform operations comprising:
implementing a first virtual AP (VAP) in a first basic service set identifier (BSSID) set and a second VAP in a second BSSID set, wherein the first BSSID set is different from the second BSSID set;
receiving, on the first VAP, a request frame from the second VAP;
transmitting, from the first VAP, a response frame to the second VAP; and
receiving, on the first VAP, a handover frame from the second VAP indicating that the second VAP accepts the request frame, wherein the response frame indicates that the first VAP and a third VAP that is in the first BSSID set have access to exchange data.

2. The AP of claim 1, wherein the response frame from the first VAP comprises a first identifier that indicates each VAP in the first BSSID set, and wherein the handover frame from the second VAP comprises a second identifier that indicates each VAP in the second BSSID set.

3. The AP of claim 2, further comprising transmitting the first identifier to a station when the station associates with either the first VAP or the third VAP.

4. The AP of claim 1, further comprising:
determining, by the first VAP, that the first VAP and the third VAP are in the first BSSID set; and
removing control frames from communication between the first VAP and the third VAP.

5. The AP of claim 1, further comprising:
transmitting, to a station, a signal with a first field indicating that the first VAP is part of the first BSSID set, wherein the station is connected to the first VAP, and wherein the signal comprises a second field indicating a number of BSSIDs in the first BSSID set.

6. The AP of claim 1, wherein the first VAP and the third VAP use a first BSS color, and wherein the second VAP uses a second BSS color that is different from the first BSS color.

7. The AP of claim 1, further comprising:
assigning an identifier to each station in the first BSSID set, wherein each of the identifiers are greater than a minimum value, wherein the minimum value is a number of association IDs allocated for advertising group traffic, wherein each of the identifiers comprises less bits than each BSSID identifier for a plurality of VAPs in the first BSSID set.

8. The AP of claim 1, further comprising:
transmitting, to a station connected to the first VAP, a report comprising an indicator that the first VAP and the third VAP are in the first BSSID set.

9. A method comprising:
receiving, at a first virtual access point (VAP) in a first basic service set identifier (BSSID) set, a request frame from a second VAP in a second BSSID set that is different from the first BSSID set;
transmitting a response frame from the first VAP to the second VAP; and
receiving, at the first VAP, a handover frame from the second VAP indicating that the second VAP accepts the request frame, wherein the response frame indicates that the first VAP and a third VAP that is in the first BSSID set have access to exchange data.

10. The method of claim 9, wherein the response frame from the first VAP comprises a first identifier that represents each VAP in the first BSSID set, wherein the response frame from the second VAP comprises a second identifier that represents each VAP in the second BSSID set, and further comprises transmitting the first identifier to a station when the station connects to either an VAP in the first BSSID set.

11. The method of claim 9, further comprising:
transmitting, to a station, a signal with a first field indicating that the first VAP is part of the first BSSID set, wherein the station is connected to the first VAP, and wherein the signal comprises a second field indicating a number of BSSIDs in the first BSSID set.

12. The method of claim 9, wherein the first VAP and the third VAP use a first BSS color, and wherein the second VAP uses a second BSS color that is different from the first BSS color.

13. The method of claim 9, further comprising:
transmitting, to a station connected to the first VAP, a report comprising an indicator that the first VAP and the third VAP are in the first BSSID set.

14. The method of claim 9, further comprising:
determining the first VAP and the third VAP are in the first BSSID set; and
removing control frames from communication between the first VAP and the third VAP.

15. The method of claim 9, further comprising:
assigning an identifier to each station in the first BSSID set, wherein each of the identifiers are greater than a minimum value, wherein the minimum value is a number of association IDs allocated for advertising group traffic, wherein each of the identifiers comprises less bits than each BSSID identifier for a plurality of VAPs in the first BSSID set.

16. A non-transitory computer-readable medium containing computer program code that, when executed by operation of one or more computer processors, performs operations comprising:
receiving, at a first virtual access point (VAP) in a first basic service set identifier (BSSID) set, a request frame from a second VAP in a second BSSID set that is different from the first BSSID set;
transmitting a response frame from the first VAP to the second VAP; and
receiving a handover frame from the second VAP indicating that the second VAP accepts the request frame, wherein the response frame indicates that the first VAP and a third VAP that is in the first BSSID set have access to exchange data.

17. The non-transitory computer-readable medium of claim 16, the operations further comprising:
transmitting a signal to a station with a first field indicating the first VAP is part of the first BSSID set, wherein the station is connected to the first VAP, and wherein the signal comprises a second field indicating a number of BSSIDs in the first BSSID set.

18. The non-transitory computer-readable medium of claim 16, wherein the first VAP and the third VAP use a first BSS color, and wherein the second VAP uses a second BSS color that is different from the first BSS color.

19. The non-transitory computer-readable medium of claim 16, the operations further comprising:
transmitting, to a station connected to the first VAP, a report comprising an indicator that the first VAP and the third VAP are in the first BSSID set.

20. The non-transitory computer-readable medium of claim 16, the operations further comprising:
determining, by the first VAP, that the first VAP and the third VAP are in the first BSSID set; and
removing control frames from communication between the first VAP and the third VAP.
